(19) United States
(12) Patent Application Publication
(10) Pub. No.: US 2025/0076488 A1
(43) Pub. Date: Mar. 6, 2025

(54) METHOD FOR ESTIMATING CURRENT POSITIONS OF SENSOR ELEMENTS IN AN ARRAY SENSOR, COMPUTER PROGRAM PRODUCT, COMPUTER-READABLE STORAGE MEDIUM, AND ARRAY SENSOR

(71) Applicants: Volkswagen Aktiengesellschaft, Wolfsburg (DE); Fraunhofer Gesellschaft zur Förderung der angewandten Forschung e.V., Munich (DE)

(72) Inventors: Heiko Gustav Kurz, Hannover (DE); Marc-Michael Meinecke, Sassenburg (DE); Renato Simoni, Bonn (DE); Maria Antonia González-Huici, Bonn (DE); Christian Greiff, Bonn (DE); Thomas Gisder, Wolfsburg (DE)

(21) Appl. No.: 18/809,020

(22) Filed: Aug. 19, 2024

(30) Foreign Application Priority Data
Aug. 28, 2023 (EP) 23193743.4

(51) Int. Cl. G01S 13/87; G01S 5/02; H04B 17/27

(52) U.S. Cl. CPC G01S 13/876; G01S 5/0289; H04B 17/27

(57) ABSTRACT

A system and method for estimating current positions of sensor elements in an array sensor involve providing initial position estimates by an electronic computing device, transmitting a sensor signal into the surroundings, and receiving a reflected signal from at least one calibration target. The system determines the direction of arrival of the reflected signal and analytically estimates the virtual positions of the sensor elements based on this direction and a criterion of smallest residuum. The current positions are then estimated using the virtual positions and initial estimates. The technology further includes a computer program product, a computer-readable storage medium, and an array sensor configured to perform these functions.

### RELATED APPLICATIONS

The present application claims priority to European Patent Application No. 10 2022 23193743.4, to Gustav, et al., filed Aug. 28, 2023, the contents of which is incorporated by reference in its entirety herein.

### TECHNICAL FIELD

The present disclosure relates to technologies and techniques for estimating and applying current positions of sensor elements in an array sensor. Furthermore, the present disclosure relates to a computer program product, a computer-readable storage medium as well as to an array sensor employing the presently disclosed technologies and techniques.

### BACKGROUND

Estimating the current positions of sensor elements in an array sensor is a well-known problem in the state of the art. For at least partially automated motor vehicles, it is important to know the sensor position with high precision to capture the surroundings more accurately, thereby enabling safer control of the motor vehicle in its environment.

GP 2002 344 223 A1 provides a method of determining the position of an array antenna element to improve its output performance. An array antenna unit is equipped with a STAP controller and includes the following functions: a first function is obtained by summing the expectations of the squared absolute values of auto-correlation functions of the general impulse response of all desired waves; a second function is obtained by summing the expectations of the squared absolute values of cross-correlation functions between the general impulse response of all desired waves and the general impulse response of all interference waves; a third function is the sum of the first and second functions; and a fourth function involves the relative positioning of the remaining (n-1) antennas, with reference to a specific antenna element. An antenna position designing unit determines the position of n antenna elements by calculating the positions of the other (n-1) antenna elements to minimize the fourth function.

U.S. Pat. No. 11,005,580 B2 discloses an array antenna calibration method and device used for calibrating an array antenna in real time within an open calibration environment. The method includes: determining an initial beam weight vector matrix for an array antenna to be calibrated based on a preset direction angle of each preset beam direction, and emitting a first calibration signal from a test antenna in a standard beam direction to the array antenna to be calibrated; determining, based on the first calibration signal received by each channel of the array antenna to be calibrated, a magnitude-phase arrow between the first calibration signal received by a center channel and the first calibration signal received by each channel; and using the magnitude-phase arrow to calibrate the initial beam weight vector matrix, resulting in a compensation beam weight vector matrix.

According to U.S. Pat. No. 7,714,776 B2, an antenna array comprises a surface with a replicated pattern of conductive tracks, which define multiple ports. A plurality of antennas are located at ports distributed across the surface. A plurality of radiative transceivers are electrically connected to respective antennas. Additionally, a plurality of reference transceivers are electrically connected to non-radiative impedances located at respective ports so that each reference transceiver is surrounded by a group of antennas and electrically coupled to the group of antennas via the tracks. At least one antenna from each group belongs to another group of antennas. Calibration circuitry includes a controller associated with each reference transceiver, which is configured to transmit a calibration signal through the associated reference transceiver and receive and store a calibration signal from a selected transceiver in the group of antennas coupled to the reference transceiver. The calibration circuitry further includes, for each other transceiver in the group, circuitry to adjust the phase and amplitude of signals transmitted and received by the radiative transceivers relative to the stored calibration signals for the selected radiative transceiver.

### SUMMARY

It is an object of the present disclosure to disclose a method, a computer program product, a computer-readable storage medium, and an array sensor by which improved estimation of current positions of sensor elements in the array sensor is achieved.

Certain aspects are disclosed in the respective subject matter of the independent claims. Further implementations and preferred embodiments are the subject matter of the dependent claims.

In some examples, a method for estimating current positions of sensor elements in an array sensor is disclosed. Initial position estimates of the sensor elements are determined by an electronic computing device of the array sensor. A sensor signal is transmitted in the surroundings of the array sensor by a transmitting device, and a reflected sensor signal is received by a receiving device of the array sensor, where the sensor signal is reflected on at least one calibration target in the surroundings. At least a direction of arrival of the reflected signal is determined by the electronic computing device. A virtual position of each of the sensor elements is estimated analytically depending on the direction of arrival by the electronic computing device based on a criterion of smallest residuum. The current positions are estimated depending on the virtual positions and the initial position estimates by the electronic computing device.

Thus, an analytical method for estimating current positions of sensor elements is disclosed. Determining at least a direction of arrival of a reflected signal may be performed by the electronic computing device itself or by other target localization devices or techniques.

Furthermore, the present disclosure relates to a computer-readable storage medium comprising at least the computer program product as disclosed herein.

In some examples, an array sensor is disclosed, particularly a sensor device and/or communication device for a motor vehicle or any kind of vehicle, comprising at least one transmitting device, one receiving device, and one electronic computing device, wherein the array sensor, particularly the sensor device and/or communication device, is configured to perform a method as disclosed herein.

The method may be performed by the sensor device and/or communication device.

In some examples, a motor vehicle is disclosed, comprising at least the sensor device and/or communication device as disclosed herein.

Advantageous embodiments of the method are also regarded as advantageous embodiments of the computer program product, the computer-readable storage medium, the sensor device and/or communication device, and the motor vehicle. Therefore, the sensor device and/or communication device, as well as the motor vehicle, may include means for performing the method.

The present disclosure also includes the control device/electronic computing device for the motor vehicle. The control device may comprise a data processing device or a processor device adapted to perform an example of the method as disclosed herein. For this purpose, the processor device may include at least one microprocessor and/or at least one microcontroller and/or at least one FPGA (field-programmable gate array) and/or at least one DSP (digital signal processor). A CPU (Central Processing Unit), GPU (Graphical Processing Unit), or NPU (Neural Processing Unit) may be used as the microprocessor in each case. Furthermore, the processor device may have program code configured to perform the method when executed by the processor device. The program code may be stored in a data memory of the processor device. The processor device may be based, for example, on at least one circuit board and/or at least one SoC (system on chip).

The motor vehicle according to the present disclosure is preferably designed as a motor vehicle, particularly as a passenger car or truck, or as a passenger bus or motorcycle.

As a further solution, the present disclosure also includes a computer-readable storage medium comprising program code which, when executed by a computer or computer network, causes the computer or computer network to execute an example of the method as disclosed herein. The storage medium may be disclosed at least in part as a non-volatile data storage (e.g., as a flash memory and/or as an SSD-solid state drive) and/or at least in part as a volatile data storage (e.g., as a RAM-random access memory). The storage medium may be arranged in the computer or computer network. However, the storage medium may also be operated, for example, as a so-called app store server and/or cloud server on the Internet. A processor circuit with, for example, at least one microprocessor may be disclosed by the computer or computer network. The program code may be disclosed as binary code and/or as assembly code and/or as source code of a programming language (e.g., C) and/or as a program script (e.g., Python).

The present disclosure also encompasses combinations of the features of the described examples. Thus, it also encompasses implementations that combine features of more than one of the described examples, provided that the examples have not been described as mutually exclusive.

### BRIEF DESCRIPTION OF THE DRAWINGS

Exemplary embodiments are described hereafter. In the drawings:

FIG. 1 a schematic top view according to an embodiment of a motor vehicle comprising an array sensor, according to some aspects of the present disclosure; and

FIG. 2 a schematic flow chart according to an embodiment of the method, according to some aspects of the present disclosure.

### DETAILED DESCRIPTION

In the figures the same elements are comprising the same reference signs.

As disclosed herein, the objective is to estimate three-dimensional antenna positions and complex channel imbalances for measured range/Doppler/channel maps, for example, with at least four disjoint calibration targets. When restricted to a subspace, a d-dimensional position estimate requires a number of d targets, plus one additional target if channel imbalances are also to be estimated.

Targets can be in the near-field, but their locations should ideally be “known.” The closer the target is to the array, the more precisely the range needs to be known. In the far-field, only the direction of arrival (DoA) information suffices. In principle, an estimate of target location information can be obtained even with the sensor itself. The signal-to-noise ratio (SNR) is sufficiently high to prevent noise from significantly disturbing the phases.

Prior knowledge of antenna positions is important for a successful outcome, ideally with a 3D error accuracy better than half of the operating wavelength (lambda/2).

The range of sets of peak shifts due to cable delays can also be compensated, but this task is independent of the estimation of antenna position and channel imbalances. In a dynamic scene with moving platforms, range migration over ramps must be compensated for first.

The method disclosed herein is analytical, meaning that no costly numerical optimization is required.

In the near-field case, the method relies on certain “fudge factors” (i.e., “correction coefficients” or “adjustment parameters”), which are determined from prior knowledge of antenna positions and target locations. These factors are used to pre-transform the data to eliminate unwanted terms in the bistatic range's Taylor series, which would otherwise prevent analytical treatment.

The derivation of the method assumes that the data samples are noise-free. However, it can still be applied to noisy data, although its performance may be more sensitive to noise than other methods.

As disclosed herein, at least four reflected signals from at least four calibration targets are received. It is also possible to use fewer than four calibration targets. For example, a d-dimensional position estimate requires d targets, plus one additional target if channel imbalances are also to be estimated. Therefore, if a two-dimensional position estimate is computed, just two calibration targets are used. If the two-dimensional estimation includes channel imbalances, at least three calibration targets are used. For three-dimensional estimation, three targets are used. If channel imbalances are also estimated, four calibration targets are used. This approach enables precise estimation of the current positions.

In another embodiment, the distance to at least one calibration target is disclosed, and the virtual position is additionally determined based on the disclosed distance. The distance can be provided externally. Thus, depending on the distance, precise estimation of the current sensor positions is realized.

In another embodiment, a channel imbalance of the antenna is determined based on the estimated current positions. The channel imbalances of the array sensor are also determined based on the estimated current positions. Thus, the disclosed method allows for the estimation of channel imbalances, enabling the determination of countermeasures.

In another embodiment, the channel imbalance is determined using a singular value decomposition algorithm. This provides a precise method for determining the channel imbalance.

In another embodiment, the channel imbalance is determined using a higher-order singular value decomposition algorithm. This provides a precise method for determining the channel imbalance.

In another embodiment, the initial positions are nominal positions. This allows for normalization of the data, which decouples the estimation of positions from imbalances.

In another embodiment, the estimated virtual positions are bootstrapped as the initial positions. This allows for further calculation/estimation of the positions, particularly with higher precision.

In another embodiment, the received signal is compensated for phase contributions due to geometry from the received signal. This enables more precise estimation of the current sensor positions.

In another embodiment, the sensor device is disclosed as a radar device and/or a communication device. Thus, the sensor device can be used as a radar device and/or communication device. This offers the advantage of being suitable for communication, such as with a satellite, and/or for capturing the surroundings of a motor vehicle.

As disclosed herein, the method is a computer-implemented method. Therefore, another aspect of the disclosure relates to a computer program product comprising program code means for performing the method as disclosed herein.

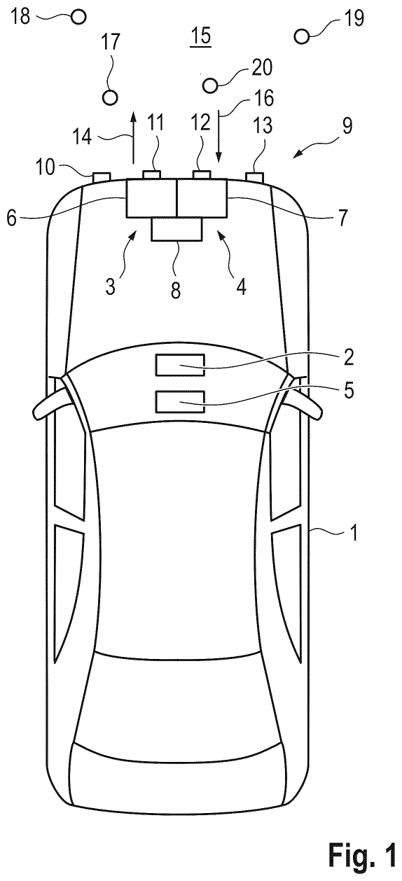

FIG. 1 shows a schematic top view according to an embodiment of a motor vehicle 1, according to some aspects of the present disclosure. The motor vehicle 1 may comprise an assistance system 2 for at least partially assisted operation of the motor vehicle 1. Furthermore, the motor vehicle 1 may comprise an array sensor 3, particularly for the assistance system 2. The array sensor 3 may be configured as a sensing device 4, as shown in FIG. 1, and/or as a communication device 5. The array sensor 3 may comprise at least one transmitting device 6, one receiving device 7, and an electronic computing device 8.

According to an embodiment of the method, initial position estimates 9 of sensor elements 10, 11, 12, 13 of the array sensor 3 are disclosed by the electronic computing device 8. As shown in FIG. 1, the array sensor 3 may comprise a first sensor element 10, a second sensor element 11, a third sensor element 12, and a fourth sensor element 13. It is understood by a person skilled in the art that the array sensor 3 may comprise fewer than four sensor elements 10, 11, 12, 13, or more than four sensor elements 10, 11, 12, 13.

A sensor signal 14 is transmitted in the surroundings 15 of the array sensor 3 by the transmitting device 6, and reflected sensor signals 16 are received by the receiving device 7, where the sensor signal 14 is reflected on at least one calibration target 17, 18, 19, 20.

At least the direction of arrival of the reflected signal 16 is determined by the electronic computing device 8. A virtual position of each of the sensor elements 10, 11, 12, 13 is estimated based on the direction of arrival by the electronic computing device 8, using a criterion of the smallest residuum. The current positions 9 are estimated based on the virtual positions and the initial positions as determined by the electronic computing device 8.

As shown in FIG. 1, at least four reflected sensor signals 16 from at least four calibration targets 17, 18, 19, 20 are received. FIG. 1 specifically shows a first calibration target 17, a second calibration target 18, a third calibration target 19, and a fourth calibration target 20. Additionally, a distance to at least one calibration target 17, 18, 19, 20 is disclosed, and the virtual position is further determined based on the disclosed distance.

Furthermore, based on the estimated current positions 9, a channel imbalance of the sensor elements 10, 11, 12, 13 is determined.

In another embodiment, the channel imbalance is determined using a singular value decomposition algorithm. Alternatively, the channel imbalance is determined using a higher-order singular value decomposition.

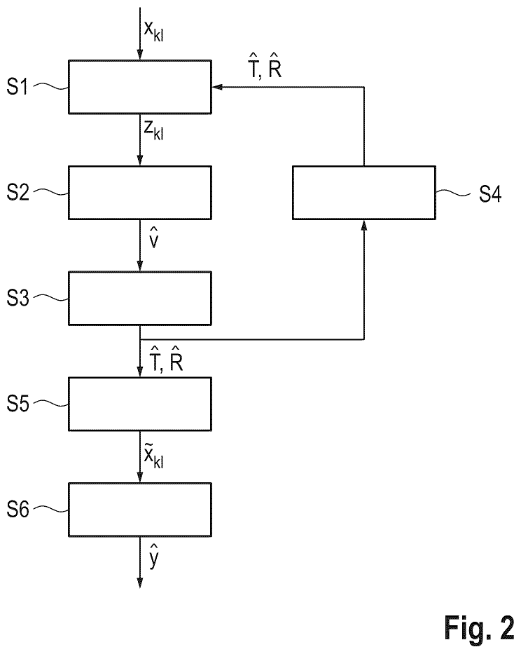

FIG. 2 shows a schematic flow chart according to an embodiment of the method. Specifically, FIG. 2 illustrates that in the first step S1, data is normalized. In the second step S2, virtual positions are estimated. In the third step S3, the real positions are estimated. In the fourth step S4, the estimated positions are bootstrapped back to the first step S1. Following the third step S3, a fifth step S5 is performed, wherein the data is compensated. In the sixth step S6, the channel imbalances are estimated.

Specifically, FIG. 2 shows that in the first step S1, an element-wise division by data from a selected reference channel and reference targets is performed, along with compensation of unwanted terms using a “fudge factor” (i.e., “correction coefficient” or “adjustment parameter”) In the second step S2, the virtual positions are estimated. An analytic solution for each hypothesis of unwrapping that could have resulted in the measured phases is performed. The virtual positions are estimated based on the criterion of the smallest residuum. In the third step S3, the real positions are estimated. Specifically, a pseudo-inversion and a fixed origin from prior knowledge of the sensor elements' positions are used. Optionally, the fourth step S4 is performed, wherein the current estimates are bootstrapped as prior knowledge. In the fifth step S5, the data is compensated. The estimated positions and potentially accepted target model are used to eliminate the phase contribution due to geometry from the data. In the sixth step S6, the channel imbalance is estimated using SVD or HOSVD.

Now, the steps S1 to S6 are presented in more detail. According to the first step S1, normalization of the data is disclosed.

An array consists of Tx m=1, . . . , N_{Tx} and Rx n=1, . . . , N_{Rx} with (3D Cartesian) positions tₘ, rₙ∈ [symbol] ³, respectively. Radar operates at wavelength λ.

Data model for range/Doppler snapshots: For Cartesian target location pₖ,

$${x}_{k l} = {s}_{k} {γ}_{l} exp ( i \frac{2 π}{λ} ( \vert {p}_{k} - {t}_{m} \vert + \vert {p}_{k} - {r}_{n} \vert ) )$$

where k=0, . . . , K targets and l=(m, n)=0, . . . , L virtual channels with position

$$v = \frac{t + r}{2} .$$

The complex channel imbalances are γₗ, while sₖ are the target amplitudes. Note that virtual positions are defined here as the mean, not just the sum, of Tx and Rx position. Note also there is no additive Gaussian noise in the model.

Select a virtual ‘reference channel’ (wlog, l=0), which will also serve as coordinate origin v₀=0 in the following.

Divide now element-wise by the signal in the reference channel and compensate with the following (estimated) residual phases

$${y}_{k l} := exp ( - i \frac{2 π}{λ} {\hat{Δ}}_{k l} ) \frac{{x}_{k l}}{{x}_{k 0}} \approx exp ( - i \frac{2 π}{λ} {Δ}_{k l} ) \frac{{x}_{k l}}{{x}_{k 0}} = \frac{{γ}_{l}}{{γ}_{0}} exp ( i \frac{2 π}{λ / 2} ( - {u}_{k}^{H} {v}_{l} + \frac{{f}_{k l}}{\vert {p}_{k} \vert} {\vert {v}_{l} \vert}^{2} ) )$$

where (omitting indices k, l, etc)

$$Δ = \vert p - t \vert + \vert p - r \vert - ( \vert p - {t}_{0} \vert + \vert p - {r}_{0} \vert ) - 2 ( - {u}^{H} v + \frac{f}{\vert p \vert} {\vert v \vert}^{2} )$$

and \hat{Δ} analogously, with antenna positions (and in a potential extended version of the method also target locations) replaced with their priors. The target direction (DoA) is denoted by u.

Here, a correction coefficient f is introduced, which is usually set to

$$f = \frac{\vert p \vert}{4 {\vert \hat{v} \vert}^{2}} {\hat{v}}^{H} ( 2 u - {u}_{t} - {u}_{r} )$$

$$with$$

$${u}_{t} = \frac{p - \hat{t}}{\vert p - \hat{t} \vert} , {u}_{r} = \frac{p - \hat{r}}{\vert p - \hat{r} \vert}$$

and \hat{v} the prior on virtual position.

On the choice of correction coefficients, there may be more than one valid rationale for setting these coefficients. One approach is to minimize the (first-order terms of) the RMSE under Gaussian perturbations of the ideal Δ and its practically available estimate, i.e.,

$$\hat{Δ} - Δ \approx {( {u}_{t} - u + \frac{2 f}{\vert p \vert} \hat{v} )}^{T} ϵ + {( {u}_{r} - u + \frac{2 f}{\vert p \vert} \hat{v} )}^{T} δ - {( {u}_{t 0} - {u}_{r 0} )}^{T} {ϵ}_{0}$$

$$with t = \hat{t} + ϵ , r = \hat{r} + δ , with ϵ , δ ∼ N ( 0 , {σ}_{pos}^{2} ) .$$

The result for f is independent of the error variance σₚₒₛ², whereas the RMSE scales linearly

$$E [ {( \hat{Δ} - Δ )}^{2} ] / {σ}_{p o s}^{2} = {\vert {u}_{t 0} - {u}_{r 0} \vert}^{2} + {\vert u - {u}_{t} - {P}_{\hat{v}} ( u - \frac{{u}_{t} + {u}_{r}}{2} ) \vert}^{2} + {\vert u - {u}_{r} - {P}_{\hat{v}} ( u - \frac{{u}_{t} + {u}_{r}}{2} ) \vert}^{2}$$

### Here

$${P}_{v} = \frac{v {v}^{H}}{{\vert v \vert}^{2}}$$

is the projection on v.

Note that the Δ can be estimated rather accurately even with only modest prior knowledge of antenna positions and target locations. For far-field targets, the RMSE converges to zero.

Another appropriate choice of correction coefficients is:

$$f = \frac{{\vert \hat{t} \vert}^{2} - {( {u}^{H} \hat{t} )}^{2} + {\vert \hat{r} \vert}^{2} - {( {u}^{H} \hat{r} )}^{2} - 2 ( {\vert {\hat{t}}_{0} \vert}^{2} - {( {u}^{H} {\hat{t}}_{0} )}^{2} )}{{\vert \hat{t} + \hat{r} \vert}^{2}}$$

This choice is based on the observation that

$$Δ = - \frac{2 {\vert v \vert}^{2}}{\vert p \vert} f + \frac{{\vert t \vert}^{2} - {( {u}^{H} t )}^{2} + {\vert r \vert}^{2} - {( {u}^{H} r )}^{2} - 2 ( {\vert {t}_{0} \vert}^{2} - {( {u}^{H} {t}_{0} )}^{2} )}{2 \vert p \vert} + O ( \frac{1}{\vert p \vert} ) ,$$

where O( ) here refers to Landau's big-O notation (indicating that the term is negligible if the target is sufficiently far from the array). Thus, this choice aims to eliminate the lowest-order term.

Both choices generally exhibit similar performance, with the former possibly having a slight edge in the near-field.

To avoid numerical instabilities for virtual channels near the origin (other than the reference channel), in one possible embodiment f is set to zero for those channels if it would otherwise exceed some maximum value. (Possible criterion: f<<λ|p|/σₚₒₛ²=:fₘₐₓ where σₚₒₛ is typical position error.) Usually this should not be necessary, as arrays positions are designed such that they are spread over the aperture.

Choose further a ‘reference target’ (wlog, k=0) and divide element-wise along the channel dimension to eliminate the channel imbalances

$${z}_{k l} := exp ( i {ϕ}_{k l} ) := \frac{{y}_{k l}}{{y}_{0 l}} \approx exp ( i \frac{2 π}{λ / 2} ( - {( {u}_{k} - {u}_{0} )}^{H} {v}_{l} + ( \frac{{f}_{k l}}{\vert {p}_{k} \vert} - \frac{{f}_{0 l}}{\vert {p}_{0} \vert} ) {\vert {v}_{l} \vert}^{2} ) )$$

where, again, the last equation holds only approximate in the case of estimated Δ.

This step can be skipped in case that channel imbalances have already been compensated, i.e. γₗ=const. All the formulas remain valid with the obvious modifications, e.g., f₀=0, u₀=0, K→K+1.

In the second step S2 the virtual positions are estimated. For the normalized phases of zₖₗ, defined as

$$ξ := \frac{ϕ}{2 π} \frac{λ}{2} ∈ ( - \frac{λ}{4} , \frac{λ}{4} ] ,$$

There is the equation (indices l can be dropped since the problem is decoupled in the virtual positions vₗ),

$$( \frac{{f}_{k}}{\vert {p}_{k} \vert} - \frac{{f}_{0}}{\vert {p}_{0} \vert} ) {\vert v \vert}^{2} - {( {u}_{k} - {u}_{0} )}^{T} v ∈ {ξ}_{k} + \frac{λ}{2} ℤ , for k = 1 , … , K$$

In vector notation, introduce

$$h = {( \frac{{f}_{k}}{\vert {p}_{k} \vert} - \frac{{f}_{0}}{\vert {p}_{0} \vert} )}_{k} ∈ {ℝ}^{K}$$

$$U = ( {u}_{1} - {u}_{0} , … , {u}_{K} - {u}_{0} ) ∈ {ℝ}^{3 \times K} ,$$

$$A = {( {U}^{T} )}^{+} = {( U {U}^{T} )}^{- 1} U ∈ {ℝ}^{3 \times K} ,$$

$$A h = c n , c = \vert A h \vert > 0 , n ∈ {ℝ}^{3}$$

(i.e., c→0 is far-field condition for fixed correction coefficients) and the following formula is used:

$$h {v}^{T} v - {U}^{T} v ∈ ξ + \frac{λ}{2} {ℤ}^{K} \qquad ( Eq . 1 )$$

$$or$$

$$A h {v}^{T} v - v ≡ A ξ + \frac{λ}{2} A z \text{=:} {ζ}_{z}$$

with z∈ [symbol] ^{K} (which immediately may be drop ped as subindex from ζ) This equation can be solved analytically, as shown in the following proof:
Derivation of analytic solution for (Eq.1). (This can be skipped on first reading.)

Now let Q=(n, \tilde{Q})∈SO(3). Recall that by definition of orthogonal matrices, we have I₃=QQ^{T}=nn^{T}+\tilde{Q}\tilde{Q}^{T} and Q^{T}Q=[n^{T}n, n^{T}\textcircled{Q}; \tilde{Q}^{t}n, \tilde{Q}^{T}\tilde{Q})=(1, 0^{T}; 0, I₂).

With w=Q^{T}v=(w₁; \tilde{w})∈ [symbol] ³, we have

$$c {e}_{1} {w}^{T} w - w ∈ {Q}^{T} ζ = ( {b}_{1} ; \tilde{b} )$$

$$with {b}_{1} = {n}^{T} ζ ∈ ℝ$$

$$and \tilde{b} = {\tilde{Q}}^{T} ζ ∈ {ℝ}^{2}$$

$$and {\vert ζ \vert}^{2} = {\vert {Q}^{T} ζ \vert}^{2} = {b}_{1}^{2} + {\vert \tilde{b} \vert}^{2} = {ζ}_{par}^{2} + {\vert {ζ}_{orth} \vert}^{2}$$

Stated equivalently,

$${w}_{1}^{2} - \frac{{w}_{1}}{c} + {\vert {ζ}_{orth} \vert}^{2} - \frac{{ζ}_{par}}{c} = 0$$

$$- \tilde{w} = \tilde{b}$$

from which following formula can be found

$${w}_{1}^{\pm } = \frac{1}{2 c} ( 1 \pm \sqrt{( 1 - 4 {c}^{2} {\vert {ζ}_{orth} \vert}^{2} + 4 c {ζ}_{par} )} )$$

Apparently w₁:=w₁⁻ must be the meaningful solution, as it gives results consistent with the far-field case

$${w}_{1}^{-} \to - {ζ}_{par} , c \to 0$$

while w₁⁺ diverges.

In summary, the sought-after position estimate is given by the formula

$$\hat{v} = Q ( {w}_{1} ; - \tilde{b} ) = {w}_{1} n - \tilde{Q} {\tilde{Q}}^{T} ζ = {w}_{1} n - ( {I}_{3} - {nn}^{T} ) ζ$$

In the case K=3, every ζ gives a valid solution (within the limits of prior knowledge). In the case K>3, the residiuum

$$res ( z ) = \vert h {\vert \hat{v} \vert}^{2} - {U}^{T} \hat{v} - ( ξ + \frac{λ}{2} z ) \vert$$

helps to discard ‘pseudo solutions’: a large residuum stems from comprises made by the pseudo-inverse (Eq.1), while a true solution should ideally have no residuum at all.

How exactly additional calibration targets increase the unambiguous cell depends on the precise location and seems difficult to describe.

In any case, one has to search over a grid in ζ. Prior knowledge on vₚ gives an idea for a grid center

$${z}_{p} = round ( \frac{h {\vert {v}_{p} \vert}^{2} - {U}^{T} {v}_{p}}{λ / 2} ) ∈ {ℤ}^{K}$$

The method is ‘exact’ in the far-field case

$$\hat{v} ( z ) = - A ξ - \frac{λ}{2} Az$$

and depends on correction coefficient estimate quality in the near-field case. The selection of correction coefficients could be guided by an appropriate robustness criterion.

The method can be adapted in the spatial degrees of freedom. For example, if it is known that antenna positions can vary only in a 2D plane or the target configuration is degenerated such that position estimation along one axis is not reasonably possible, one can modify the position variables to

$$t = + {a}_{0} + {e}_{x} {t}_{x} + {e}_{y} {t}_{y}$$

$$r = - {a}_{0} + {e}_{x} {r}_{x} + {e}_{y} {r}_{y}$$

$$v = {e}_{x} {v}_{x} + {e}_{y} {v}_{y} = E \tilde{v}$$

and (Eq.1) takes the form

$$\tilde{A} h {\tilde{v}}^{T} \tilde{v} - \tilde{v} ≡ {\tilde{ζ}}_{z}$$

$$\tilde{U} = {E}^{T} ( {u}_{1} - {u}_{0} , … , {u}_{K} - {u}_{0} ) ∈ {ℝ}^{2 \times K} ,$$

$$\tilde{A} = {( {\tilde{U}}^{T} )}^{+} = {( \tilde{U} {\tilde{U}}^{T} )}^{- 1} \tilde{U} ∈ {ℝ}^{2 \times K} ,$$

An analytic solution for \tilde{v}∈ [symbol] ² can be found as in the general case.

In the third step S3 the real positions are estimated. Once that estimates \hat{V}∈ [symbol] ^{3×N}^{_{Tx}}^{N}^{_{Rx}} have been found for all virtual positions, it remains to convert them back into estimates of real positions of Tx \hat{T}∈ [symbol] ^{3×N}^{_{Tx}} and Rx \hat{R}∈ [symbol] ^{3×N}^{_{Rx}}.

The (N_{Tx}N_{Rx}×N_{Tx}+N_{Rx}) matrix

$$M = [ {I}_{T} ⊗ {1}_{R} , {1}_{T} ⊗ {I}_{R} ]$$

(with I_{T}∈ [symbol] ^{N}^{_{Tx}}^{×N}^{_{Tx}} the identity matrix, and 1_{R}∈ [symbol] ^{N}^{_{Rx}}^{×N}^{_{Rx}} the matrix of ones) yields the desired solution

$$( {\hat{T}}^{T} ; {\hat{R}}^{T} ) = {M}^{+} 2 {\hat{V}}^{T} ∈ {ℝ}^{( {N}_{Tx} + {N}_{Rx} ) \times 3}$$

Adding some more rows to M is convenient for numerical stability and to fix another degree of freedom (note that shifting Rx and Tx arrays against each other leaves virtual positions unchanged). They can be used to set e.g. the array centers according to prior knowledge.

At this stage, identifying virtual position estimates that may have fallen into ambiguity traps may also be performed. If there is a single combination of Tx/Rx that is an outlier with respect to the others, it will manifest in the residuum:

$$2 {\hat{V}}^{T} - M ( {\hat{T}}^{T} ; {\hat{R}}^{T} )$$

as unusual large values, possibly larger than a wavelength A. Those rows can then be discarded, and the estimation of real positions repeated for a potentially much better overall result.

Next, the optional fourth step S4 may be performed, wherein bootstrapping with current estimates as prior knowledge is conducted. With new current estimates of antenna positions \hat{T}, \hat{R}, the steps S1 to S3 can be repeated so far with these hopefully improved estimates as prior knowledge.

This type of bootstrapping has the potential to greatly increase accuracy if the performance on the first run was already decent. On the other hand, first estimates that fell into an ‘ambiguity trap’ may become further consolidated in the wrong position, which can result in an overall degeneration of estimation quality for other channels as well.

In the fifth step S5, compensating data is performed, particularly by using the estimated positions and potentially extended target model. With estimates of antenna positions, estimates of bistatic ranges for each target of known location can also be used. Returning to the original samples, the phase due to geometry can be compensated based on the antenna position estimates:

$${\tilde{x}}_{kl} := {x}_{kl} exp ( - i \frac{2 π}{λ} ( \vert {p}_{k} - {\hat{t}}_{m} \vert + \vert {p}_{k} - {\hat{r}}_{n} \vert ) ) \approx {s}_{k} {γ}_{l} \qquad ( Eq . 2 )$$

where the last equation holds only approximately. Even if it has not been used in the steps before yet, at least in this last equation it is advisable to make use of extended target models for refined compensation of e.g. cylinder shapes (cf. Alhazen's problem).

In the sixth step S6 estimating channel imbalances can be performed by using SVD or HOSVD to find rank-1 of approximation. Channel imbalances can now be estimated easily:

For a ‘full’ model without further structure

$${min}_{γ , s} {‖ \tilde{X} - s ⊗ γ ‖}_{F}^{2}$$

the singular value decomposition (SVD) \tilde{X}=UΣV^{H} can be applied and the first column of U (corresponding to the largest singular value) as estimate for γ. (With a single target, this is just ‘conventional’ calibration routine) can be extracted.

For a ‘Kronecker’ model with structure (as appropriate for MIMO radar)

$${min}_{α , β , s} {‖ \tilde{X} - s ⊗ α ⊗ β ‖}_{F}^{2}$$

the higher order SVD for a refined estimate can be applied.

Once the current positions of sensor elements in an array sensor are accurately estimated, the vehicle can utilize this information to enhance various functions critical to its operation. For example, in the context of automated or semi-automated driving systems, precise sensor positioning allows for improved detection and tracking of objects in the vehicle's surroundings. This can result in more accurate inputs to systems responsible for collision avoidance, lane keeping, and adaptive cruise control.

By ensuring that the sensor elements are accurately aligned with the vehicle's real-time position and orientation, the array sensor can provide more reliable data to the vehicle's control systems. This, in turn, allows for better decision-making in dynamic environments, such as when the vehicle is navigating through traffic, avoiding obstacles, or responding to sudden changes in road conditions.

Furthermore, accurate sensor positioning is essential in applications where the array sensor is used as a communication device. For example, in vehicle-to-vehicle (V2V) or vehicle-to-infrastructure (V2I) communication systems, knowing the precise location of each sensor element can improve the quality and reliability of signal transmission and reception, thereby enhancing overall communication efficiency.

In addition, precise sensor positioning can be used to calibrate and optimize the vehicle's radar systems, ensuring that the radar accurately maps the environment and detects objects with high precision. This capability is particularly important in scenarios where the vehicle must operate in complex environments, such as urban areas or highways, where the ability to accurately detect and track multiple objects simultaneously is critical.

Overall, the accurate estimation of sensor positions within the array sensor contributes to the vehicle's ability to interact with and respond to its environment effectively, thereby improving safety, efficiency, and overall performance.

### REFERENCE SIGNS

1 motor vehicle
2 assistance system
3 array sensor
4 sensing device
5 communication device
6 transmitting device
7 receiving device
8 electronic computing device
9 current position
10 first sensor element
11 second sensor element
12 third sensor element
13 fourth sensor element
14 sensor signal
15 surroundings
16 reflected sensor signal
17 first calibration target
18 second calibration target
19 third calibration target
20 fourth calibration target
S1-S6 steps of the method

1. A method for estimating current positions of sensor elements in an array sensor, comprising:
providing initial position estimates of the sensor elements by an electronic computing device of the array sensor;
transmitting a sensor signal into surroundings of the array sensor by a transmitting device of the array sensor and receiving a reflected sensor signal by a receiving device of the array sensor, wherein the sensor signal is reflected from at least one calibration target in the surroundings;
determining at least a direction of arrival of the reflected sensor signal by the electronic computing device;
estimating a virtual position of each of the sensor elements using mathematical modeling based on the direction of arrival and a criterion of smallest residuum by the electronic computing device;
estimating current positions of the sensor elements based on the virtual positions and the initial position estimates by the electronic computing device; and
configuring the estimated current positions for controlling at least one vehicle function.

2. The method of claim 1, wherein receiving the reflected sensor signal comprises receiving at least four reflected sensor signals from at least four calibration targets, wherein the received reflected sensor signals are used to determine the direction of arrival and estimate the current positions of the sensor elements.

3. The method of claim 1, further comprising at least one of (i) determining the virtual position based on a distance to at least one calibration target, and/or (ii) determining a channel imbalance of the sensor elements based on the estimated current positions.

4. The method of claim 3, wherein the channel imbalance is determined using a singular value decomposition algorithm.

5. The method of claim 3, wherein the channel imbalance is determined using a higher-order singular value decomposition algorithm.

6. The method of claim 1, wherein the initial position estimates are nominal positions.

7. The method of claim 1, wherein the estimated virtual positions are bootstrapped as the initial positions.

8. The method of claim 1, further comprising at least one of (i) normalizing the received sensor signal before estimating the virtual positions, (ii) filtering the received sensor signal to remove outliers before estimating the current positions, and/or (iii) compensating the received sensor signal for phase contribution due to geometry.

9. The method of claim 1, wherein the array sensor is configured as a radar device or a communication device.

10. An array sensor configured as a sensor device and/or a communication device for a motor vehicle, comprising:
at least one transmitting device configured to transmit a sensor signal into surroundings of the array sensor;
at least one receiving device configured to receive a reflected sensor signal from at least one calibration target in the surroundings;
an electronic computing device configured to:
provide initial position estimates of sensor elements in the array sensor;
determine at least a direction of arrival of the reflected sensor signal;
estimate a virtual position of each of the sensor elements using mathematical modeling based on the direction of arrival and a criterion of smallest residuum;
estimate current positions of the sensor elements based on the virtual positions and the initial position estimates; and
configure the estimated current positions for controlling at least one vehicle function.

11. The array sensor of claim 10, wherein the at least one receiving device is further configured to receive at least four reflected sensor signals from at least four calibration targets, and wherein the received reflected sensor signals are used by the electronic computing device to determine the direction of arrival and estimate the current positions of the sensor elements.

12. The array sensor of claim 10, wherein the electronic computing device is further configured to perform at least one of:
determining the virtual position based on a distance to at least one calibration target, and/or
determining a channel imbalance of the sensor elements based on the estimated current positions.

13. The array sensor of claim 12, wherein the electronic computing device is configured to determine the channel imbalance using a singular value decomposition algorithm.

14. The array sensor of claim 12, wherein the electronic computing device is configured to determine the channel imbalance using a higher-order singular value decomposition algorithm.

15. The array sensor of claim 10, wherein the initial position estimates provided by the electronic computing device are nominal positions.

16. The array sensor of claim 10, wherein the electronic computing device is configured to bootstrap the estimated virtual positions as the initial positions.

17. The array sensor of claim 10, wherein the electronic computing device is further configured to perform at least one of:
normalizing the received sensor signal before estimating the virtual positions,
filtering the received sensor signal to remove outliers before estimating the current positions, and/or
compensating the received sensor signal for phase contribution due to geometry.

18. The array sensor of claim 10, wherein the array sensor is configured as a radar device or a communication device.

19. A non-transitory computer-readable storage medium storing instructions that, when executed by an electronic computing device of an array sensor, cause the electronic computing device to:
provide initial position estimates of sensor elements in the array sensor;
transmit a sensor signal into surroundings of the array sensor using a transmitting device of the array sensor;
receive a reflected sensor signal using a receiving device of the array sensor, wherein the sensor signal is reflected from at least one calibration target in the surroundings;
determine at least a direction of arrival of the reflected sensor signal;
estimate a virtual position of each of the sensor elements using mathematical modeling based on the direction of arrival and a criterion of smallest residuum;
estimate current positions of the sensor elements based on the virtual positions and the initial position estimates; and
configure the estimated current positions for controlling at least one vehicle function.

20. The non-transitory computer-readable storage medium of claim 19, wherein the instructions further cause the electronic computing device to:
receive at least four reflected sensor signals from at least four calibration targets; and
use the received reflected sensor signals to determine the direction of arrival and estimate the current positions of the sensor elements.
